(19) United States
(12) Patent Application Publication
(10) Pub. No.: US 2007/0112655 A1
(43) Pub. Date: May 17, 2007

(54) Prepaid financial account incentives system and method

(76) Inventor: James G. Jones, Alamo, CA (US)

Correspondence Address: REINHART BOERNER VAN DEUREN S.C.;ATTN: LINDA KASULKE, DOCKET COORDINATOR, 1000 NORTH WATER STREET, SUITE 2100, MILWAUKEE, WI, 53202, US

(21) Appl. No.: 11/260,898

(22) Filed: Oct. 28, 2005

(51) Int. Cl. G06Q 40/00; G06Q 30/00

(52) U.S. Cl. 705/35; 705/14

(57) ABSTRACT

A system and method for creating and managing incentives for buyers of prepaid financial accounts to engage in certain activities with those accounts. Account holders agree to fund a prepaid account with a minimum amount and to forego using the account for an agreed time period in exchange for a reward. The reward may be a money reward, merchandise, discounts, services, enrollment in loyalty programs, preferential treatments, rebates, lottery entries, etc. Whether or not the conditions for a reward are satisfied, the full initial par value of the account is available upon activating the account. Increasing rewards may be issued for increasing time periods where the account remains inactive.

### FIELD OF THE INVENTION

The present invention pertains generally to financial accounts and to computer based systems and methods for managing automatically such accounts, and more particularly to prepaid or stored value accounts and systems and methods for encouraging specific account activities with respect to such accounts by holders thereof and systems and methods for managing the same.

### BACKGROUND OF THE INVENTION

Banks and other financial institutions, referred to generically herein as financial institutions, make available to their individual, commercial, and institutional customers a variety of different types of financial accounts. Such accounts range, for example, from basic checking and savings accounts to credit card accounts, retirement accounts, brokerage accounts, etc. These varieties of financial accounts allow customers of financial institutions great flexibility in the ways that they may save, spend, and invest their money. A single customer may hold various different accounts with a single financial institution. Such different accounts may be integrated in a variety of ways. For example, a customer's savings account may be tied to his checking account such that any overdraft of the checking account is automatically made good from funds on deposit in the savings account. By integrating accounts in various ways, financial institution customers are provided with even greater flexibility.

Financial institutions make money from the various accounts that are maintained by them for their customers in a variety of ways. For example, for deposit type accounts, the financial institution is able to loan funds on deposit with the financial institution at an interest rate higher than that paid to depositors, and thereby make a profit. Significant earnings may be made by financial institutions from interest charged on accounts. Another source of revenue for financial institutions is fees that may be applied by the financial institution to various accounts. For example, consumers may be required to pay periodic fees for maintaining accounts, such as annual fees. Each time a payment card (such as a credit or debit card) is used a fee is paid by the merchant at which the card is used, a portion of which is returned to the financial institution issuing the card. Fees may be charged for account activities performed by customer account holders based on various account related conditions. For example, periodic fees charged to customers for certain deposit and checking accounts may be reduced as the balances maintained in the accounts are increased. Credit card holders may be charged fees (in addition to interest fees) for cash advances from credit card accounts. (Such transaction fees typically are not charged for standard purchase transactions made with a credit card account.) Fees also may be charged to a customer for failure to abide by the rules imposed by the financial institution for maintaining the account. For example, such fees may be imposed for exceeding the account limits (account overdrawn) or failure to make a payment or making a late payment on a loan, etc.

Financial institutions, therefore, desire to increase earnings both by encouraging potential customers to open and use accounts with a particular financial institution, rather than with a competing financial institution, and, after an account has been established, by encouraging the account holder to engage in particular account activities that may produce larger fees, interest collections, and/or other revenue for the financial institution. For example, as an incentive to put money on deposit with a financial institution, and keep it there, a financial institution may reduce fees, and/or increase interest paid, as the amount on deposit by a customer with the financial institution increases. In this case, the revenue lost by the banking entity due to reduced fees and increased interest payments to the account holder is more than offset by earnings gained by the financial institution from use by the financial institution of the larger amount of money made available by the depositor.

Credit card issuers, in particular, have employed a variety of schemes to encourage customers to open credit card accounts and to use those accounts in ways that will bring more revenue to the credit card issuer. For example, a credit card issuing financial institution may advertise a very low initial interest rate to encourage customers to open accounts. (These low interest rates may be increased at a later date.) Once an account is opened, the credit card issuer may try to encourage active use of the credit card account by providing the customer various incentives or rewards. For example, the card holder may be provided a reward, either in the form of cash back, discount certificates, etc., in relation to the purchases made by the customer using the account. The more that the customer charges to the account, the greater the reward provided. The reward may be provided by the financial institution itself or provided in association with a particular merchant or group of merchants with which the financial institution has established a joint marketing relationship. Thus, the reward may be points that can be used for discounts at a particular merchant or group of merchants, such as “frequent flyer” miles that may be redeemed for travel on a particular airline or airlines. Additionally, purchases at the particular merchant or merchants involved in such a partnering relationship may result in more valuable rewards, or the more rapid accumulation of points toward achieving a reward threshold level. In another scheme, credit card issuers may offer an entry into a drawing for prizes each time a credit card holder uses a credit card associated with a particular account over a certain period of time. Thus, the credit card holder is encouraged to use his credit card often, thereby to increase his chances of winning a prize.

U.S. patent application Ser. No. 10/891,410 by inventors A. Wayne Johnson and Robert Riddett and entitled “Financial Account Up-Front Incentives Management System and Method” describes a unique system and method for providing incentives to holders of credit card and other financial accounts. In accordance with the system and method described, an account holder is provided a reward before an agreed-upon account related activity is performed by the account holder. Thus, the account holder is immediately rewarded and encouraged to engage in the desired account-related activity. If the customer fails to engage in the agreed-upon activity, the customer's account may be charged for all or a portion of the cost of the reward provided up-front to the customer.

An increasingly popular form of payment are prepaid financial accounts, also known as stored value cards. Prepaid accounts differ from credit card accounts in that, with prepaid cards, the underlying card account is funded up-front by the card purchaser. A common example of such prepaid accounts are merchant gift cards that are offered at many retail stores, restaurants, and the like. These typically are purchased at a specified amount and may be used to make purchases at the store where the card was purchased and, sometimes, at other store locations and related retailers. Thus, the use of these cards, which are a replacement for paper gift certificates, typically is limited to one or a very limited number of retailers. On the other hand, there typically is no fee associated with the purchase of such cards. Therefore, the purchase and use of these types of cards is growing in popularity. In this case, the card issuer makes money from (1) the goods or services purchased by the customer using the card, (2) revenue due to the float value of the money received between the time of purchase of the card (funding of the account) and the time that it is used, and (3) cards that are purchased but never used. (Some card issuers may charge penalties to the card value if the card is not used within a certain time period.) Transactions using such merchant issued gift cards may be known as closed loop transactions, since the card issuer from which the card is purchased and the entity with which the card value is redeemed are the same.

Another type of prepaid or stored value account are general purpose gift cards. The underlying account represented by such cards also is funded up-front. However, unlike merchant issued gift cards, such general purpose gift cards may be used at many different unrelated merchants. Transactions using such general purpose gift cards are processed using one of the major credit card processing networks, e.g., MasterCard, Visa, Discover, American Express, etc., and thus are accepted at any merchant that accepts such branded cards. General purpose gift cards may be issued by banks and other financial institutions and the like. Transactions using such general purpose gift cards may be known as open loop transactions, since the card issuer from which the card is purchased and the entity with which the card value is redeemed typically are unrelated. Such general purpose gift cards have experienced limited popularity so far. One challenge with such cards is that the card issuer must often resort to charging fees, at the time of purchase and/or periodically, to the card account, in order to cover the cost of issuing and maintaining the card account and to make a profit at the end of the day. Despite the convenience and flexibility of such cards, only limited consumers appear to be ready to pay a fee for such cards, and thus continue to use checks, cash, and other mediums of exchange instead.

General purpose gift cards and other similar prepaid financial accounts, nevertheless, represent another potential service that can be provided to financial institution customers and another potential revenue stream for the financial institution, if such a prepaid account program can be implemented and managed profitably by the financial institution. Besides fees, which are unpopular with customers, financial institutions can make money off of prepaid accounts in other ways. For example, the financial institution can make money by investing or lending the funds that are paid up-front by the customer to fund a prepaid account, but typically only if the funds are not expended, i.e., the prepaid account is not used by the customer, for a sufficiently long period of time after the account is funded. What is desired, therefore, is an improved and effective system and method for encouraging a customer to fund a prepaid account and to use the account in a way that is profitable to the account issuer and rewarding to the account holder.

Any such desirable system and method for rewarding prepaid account holders for particular types of account activities preferably is implemented for substantially automatic operation in a computer based system. Computer systems currently are employed to manage and maintain the wide variety of financial accounts provided by financial institutions to their customers. Account management computer programs implemented on computer systems perform a wide variety of account management functions, such as facilitating the establishment (opening) of accounts, maintaining general account records and balances, posting debits and credits to accounts, automatically transferring funds between accounts at appropriate times, automatically issuing account statements to customers (as well as to the financial institution itself), etc. Any improvement to existing financial account management systems and processes should, to the greatest extent possible, be implemented for automatic operation as part of, or as an addition to, existing computer based financial account management systems.

### SUMMARY OF THE INVENTION

The present invention provides a system and method for rewarding holders of prepaid financial accounts for engaging in certain activities associated with those accounts. The present invention is applicable to any type of prepaid financial accounts including, but no limited to, merchant issued gift cards and general purpose gift cards. In accordance with the present invention, a customer purchaser of a prepaid account is offered a special incentive. If the customer does not activate or use the account for at least a specified period of time after the account is funded the customer will be provided with a reward. The reward may take many forms, including an increase in the value of the prepaid account, merchandise, discounts, services, enrollment in loyalty programs, preferential treatments, rebates, lottery or other contest entries, etc. The specific reward to be granted may be determined or selected by the customer at the time that the customer agrees to the conditions of the reward or at the time that the conditions are satisfied and the reward is earned.

In accordance with the present invention a customer is offered an opportunity to open a prepaid financial account and to receive a reward or rewards if the account is not used by the customer for a specified time period after the account is funded. If the customer agrees to the conditions specified for a reward, the customer funds the account for an agreed upon amount. The customer's prepaid account is opened at par value, i.e., the amount paid by the customer, less any fees that may be charged up front. If the customer activates or uses the prepaid account before the specified time period expires, the customer does not receive the reward. However, the account is still available to the customer at full par value (less any account opening fees). On the other hand, if the customer waits until after the specified time period has expired to activate or use the account the account is available to the customer at full par value (less any account opening fees) plus the reward is provided to the customer. Several reward threshold time periods may be agreed upon between the account issuer and the customer such that more rewards and/or more valuable rewards are earned by the customer the longer that the customer delays activating or using the account beyond the agreed upon time periods.

A prepaid account incentives system and method in accordance with the present invention may be implemented in a computer system, preferably as part of the computer system that is used to process purchase transactions using such a prepaid account. For example, such a processor system may be run by a financial institution that issues the prepaid account to customers of the financial institution or by a third party service provider. The processor may be in communication with the customer via a variety of communications channels, including mail, telephone (e.g., using live representatives and/or a voice response unit (VRU)), facsimile, and/or a computer network (such as the Internet). Using such communications channels, prepaid account incentive offers, account statements, and reward notices (or the rewards themselves) may be provided to the customer. The customer preferably may be able to accept prepaid account incentive offers, fund prepaid card accounts, and activate an opened account using such communications channels to the processor system. The processor employs one or more databases to maintain account information such as the account number, the opening par value of the account, the current value of the account, whether the account has been opened and used, the agreed upon time period(s) required to issue a reward, the agreed upon award to be issued, etc. The processor preferably also is coupled to a processing network to receive and process account use transactions by the customer at merchant points of sale.

Further objects, features, and advantages of the present invention will be apparent from the following detailed description taken in conjunction with the accompanying drawings.

### BRIEF DESCRIPTION OF THE DRAWINGS

FIG. 1 is a schematic flow chart diagram of a general exemplary prepaid account incentives method in accordance with the present invention.

FIG. 2 is a schematic block diagram of an exemplary system for implementing a prepaid account incentives system and method in accordance with the present invention.

FIG. 3 is a schematic flow chart diagram illustrating in more detail an exemplary prepaid account incentives method in accordance with the present invention.

FIG. 4. is a schematic flow chart diagram illustrating in detail a portion of an exemplary prepaid card incentives method in accordance with the present invention wherein increasing rewards are provided in response to delaying use of the prepaid account for increasing periods of time.

FIG. 5. is a schematic flow chart diagram illustrating in detail a portion of an alternative embodiment of an exemplary prepaid account incentives method in accordance with the present invention wherein increasing rewards are provided in response to delaying use of the prepaid account for increasing periods of time.

### DETAILED DESCRIPTION OF THE INVENTION

The present invention will be described in detail herein generally with reference to the use thereof in association with general purpose gift card type prepaid financial accounts that may be issued either directly or indirectly by financial institutions and the like. It should be understood, however, that the present invention is applicable to any type of prepaid or stored value financial account, including such accounts as may be issued directly by merchants and other entities for use by customers with the issuing entity or a limited group of related entities. This may include prepaid accounts that are accessed using a gift card or house or other prepaid accounts that operate in the same manner although an access card may not be issued. It should also be understood that the present invention is applicable to prepaid accounts that are funded directly by customers or indirectly for customers by a third party. For example, prepaid accounts may be funded for a customer by a third party as a means of transferring funds to the customer from an employer (payroll cards), as an insurance settlement from an insurance company, etc. (In such case, the rewards earned if the customer delays use or activation of the account for a selected period of time may be awarded to the customer and/or to the third party that originally funded the account.)

The present invention also will be described herein with reference to prepaid accounts that are generally accessed using a card or similar physical device but wherein the value of the account is maintained in a database outside of the card itself. Access to and maintenance of the account value is accomplished via reference to an account number that can be printed and/or stored magnetically or otherwise included on the card. However, it should be understood that the present invention also is applicable, with appropriate modification, to prepaid cards and card processing systems wherein the account value is maintained in a memory chip or other medium on the card itself. The present invention is generally applicable to prepaid financial accounts wherein any method or device may be used to access the account value, even where no card or other physical device is issued, e.g., prepaid accounts that are accessed using biometrics, such as fingerprint scans.

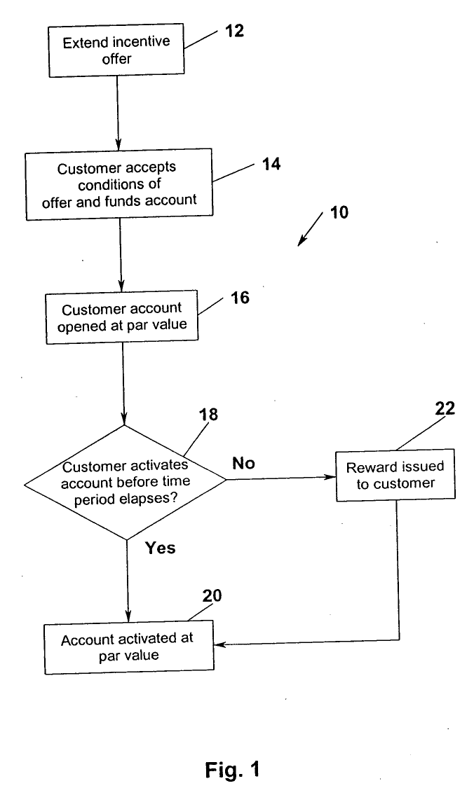

A general exemplary method 10 in accordance with the present invention for providing an incentive to a customer to use a prepaid account in a desired manner is illustrated in, and will be described with reference to, FIG. 1. The process begins with the account issuer, or a third party on behalf of the account issuer, extending 12 an incentive offer in accordance with the present invention to a prospective purchaser of a prepaid financial account. In addition to the common terms of a prepaid card account, the offer 12 will specify a minimum purchase price or initial funding amount for the account along with one or more time periods. If the customer funds the account for at least the minimum amount and does not activate or use the account for at least a minimum specified time period a reward will be provided to the customer. The reward to be provided may be specified by the offer 12 or the customer may be able to select from among a group of available rewards. (The customer may be able to make such a selection at the time of opening the account or later, at the time that the reward is earned.) Exemplary possible rewards include money (e.g., an increase in the value of the account), merchandise, discounts, services, enrollment in loyalty programs, preferential treatments, rebates, lottery or other contest entries, etc.

If the customer accepts 14 the terms of the incentive offer, the customer will be asked to fund the account. This may be accomplished via a cash payment, check, money order, a charge to another account, or in any other appropriate manner. With the account funded 14 by the customer the account is opened 16 at par value (i.e., the amount paid by the customer to open the account less any up-front fees charged to the customer) and the customer may be issued a prepaid payment card to access the account.

The activity of the customer is monitored to determine when the customer activates 18 or uses the prepaid account. If the customer activates or uses the account before the time period agreed upon in the incentive offer expires, no reward is provided to the customer. However, the account is activated 20 and the full par value of the account is available for use by the customer. If the customer first uses or activates the prepaid account after the time period specified in the incentive offer expires, the agreed upon reward is issued 22 to the customer. In addition to the reward, the account is activated 20 and the full par value of the account is available for use by the customer. Thus, the customer is provided an incentive to open and use a prepaid account in a manner that is both valuable to the account issuer, allowing the account issuer to invest and/or loan the account funds for an extended period of time, and rewarding to the account holder customer.

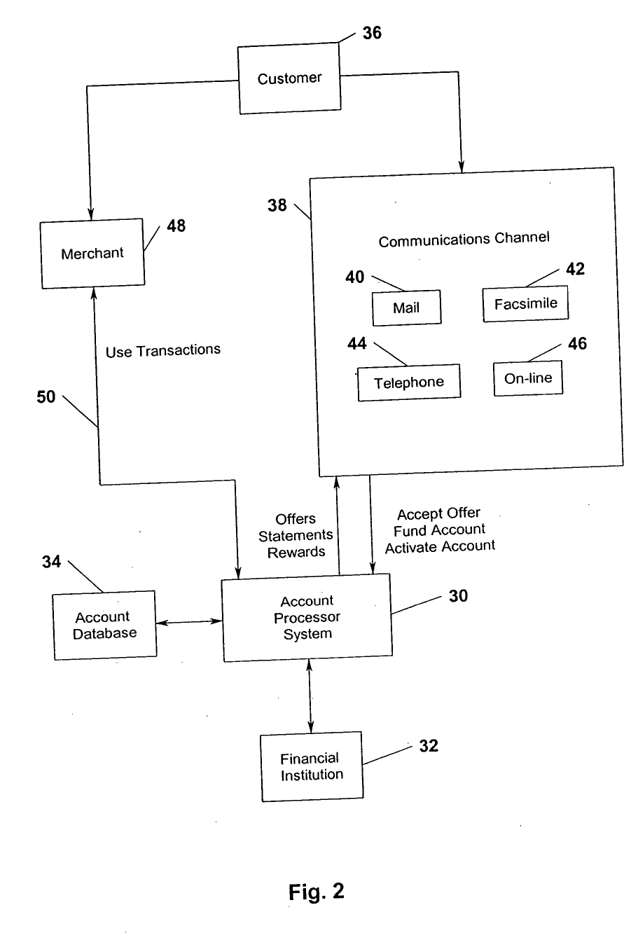

A prepaid account incentives system and method in accordance with the present invention preferably is implemented in a computer based processor system 30, as illustrated in FIG. 2. As will be apparent to those skilled in the art of computer based financial account processing, the functions performed by a prepaid account incentives system and method in accordance with the present invention are an extension of and rely upon conventional computer based systems and processes for processing prepaid account issuance and use transactions. Thus, a person of ordinary skill in the art will be able to implement a prepaid account incentives system and method in accordance with the present invention on conventional current or future computer systems, using conventional programming languages and operating systems, based on the detailed functional description and flow chart diagrams provided herein. It should be noted that the processor system 30 functionality described herein may be split between several computer systems that are operated by various entities. For example, a single entity (e.g., a financial institution or merchant) may issue a prepaid account, process and monitor account transactions, and issue rewards in accordance with the present invention using a single integrated computer system. Alternatively, and more likely, account issuance, processing, and reward issuance and other functions may be split between different entities using separate computer systems that are in communication with each other via appropriate networks or otherwise to provide seamless operation from the point of view of the customer account holder.

The processor 30 may be in communication with a financial institution 32, such as a bank, savings and loan, credit union, or the like. As just discussed, the financial institution 32 may operate the processor system 30. Alternatively, the processor system 30 may be operated by a third party on behalf of the financial institution 32. In the embodiment of the invention being described, the financial institution 32 is the prepaid account issuer, and is the entity that maintains the underlying prepaid account financial account. Thus, the financial institution 32 holds the funds representing the prepaid account. As discussed above, another type of entity, such as a merchant, may, alternatively, be the account issuer and maintain the underlying account either alone or in association with a financial institution.

The processor system 30 maintains one or more account databases 34, either independently from or in association with the financial institution 32 or other entity. The account database 34 may include customer account identifying information, such as the account number, name, address, and other contact information for the account owner, the account opening or par value, the current account value, agreed upon period(s) for delaying use of the account by a customer in order to obtain a reward, rewards selected, reward issuance status, etc.

The processor system 30 may be in communication with a prepaid account customer 36 via a variety of communications channels 38. These variety of communications channels 38 are used to provide offers and information to the customer 36 from the processor 30 and to receive information and requests from the customer 36. Information provided to the customer 36 via the communications channels 38 may include offers for prepaid accounts with incentives in accordance with the present invention, account statements, communications concerning rewards earned, or failed to be earned, by the customer 36, etc. Information received from the customer 36 via the communications channel 38 may include acceptance of a prepaid account incentive offer, information needed to fund a prepaid account, account activation requests, etc.

Exemplary communications channels 38 that may be provided between the processor system 30 and the customer 36 include conventional mail 40, facsimile 42, telephone 44 and on-line or computer network 46 communications. Telephone communications 44 may include both live operator facilitated communications and/or the use of conventional automated voice response units (VRU) or similar devices. Live operators, for example, may take information from customers 36 over the telephone 44 and enter such information manually into the processor system 30 using an appropriate user interface. Live operators may also be able to access customer account information from the account database 34 to provide account status and other information to a customer 36 over the telephone 44 as part of a customer service function of the system 30. Alternatively, a VRU may be used to implement many of these functions. By use of the VRU a customer 36 can enter information into the system 30 and/or request information from the system 30 by interacting with an automated menu system using either touch tone responses or spoken commands, if the VRU supports voice recognition. Information may be provided by the system 30 to the customer via the VRU using recorded and/or computer generated voice messages in a conventional manner.

On-line 46 communications between a customer 36 and the processor system 30 may be provided via any appropriate computer network. For example, on-line 46 communications may be provided via a web-site on the Internet that is provided either by or for the financial institution 32 or another account issuing entity. Various pages on the web site may be used to provide information to customers 36 and user interfaces may be provided to receive information from customers 36 regarding pre-paid card financial accounts in accordance with the present invention. On-line 46 communications between the processor system 30 and the customer 36 also may be provided via e-mail.

A customer 36 account holder may use a prepaid account with incentives in accordance with the present invention to make purchases in a conventional manner from, for example, a merchant 48. A payment card may be physically presented to the merchant 48, or the account number and, perhaps, other identifying information, may be provided over the phone, via mail, or via the Internet to the merchant 48. No matter how the account number is provided, the requested account transaction preferably is processed 50 electronically in a conventional manner by the processor system 30. This may be accomplished by a direct computer network or other connection 50 between the merchant 48 and the processor system 30. Alternatively a conventional processing system network (MasterCard, Visa, Discover, American Express, etc.) may be used. The processor 30 processes the use of the prepaid account by verifying that there is sufficient current account value to cover the requested purchase amount, and, if this is the case, deducting the value of the customer purchase from the prepaid account value and providing a message back to the merchant 48 that the transaction has been approved. Identifying information (e.g., the time and/or date) regarding the transaction is noted.

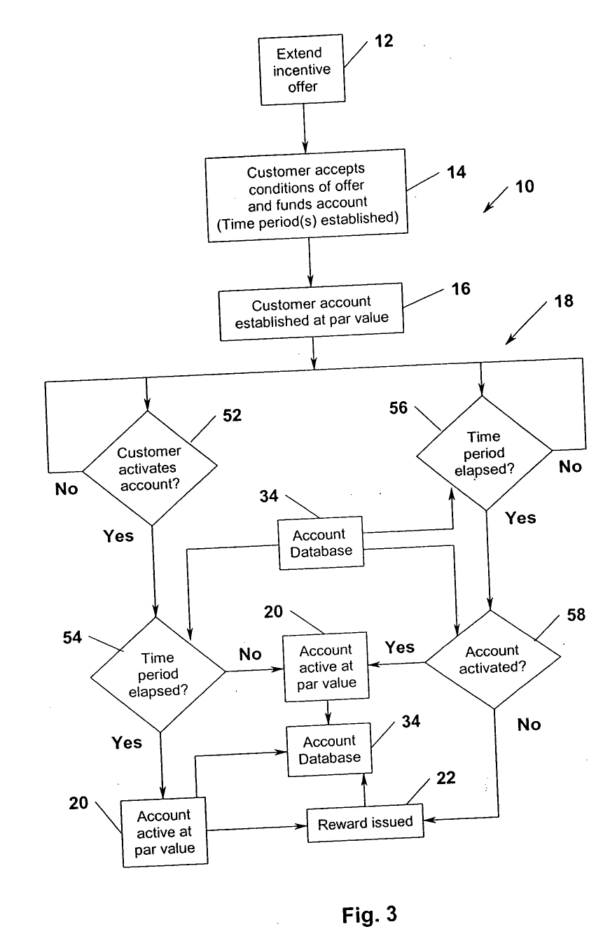

A more detailed description of an exemplary prepaid account incentives method 10 in accordance with the present invention employing the processor system 30 now will be provided with reference to FIG. 3.

A prepaid account incentive offer 12 may be extended to a potential customer 36 via a variety of different communications channels 38 and in a variety of different manners. For example, an offer 12 may be extended via a direct or mass mailing 40 to the customer 36. The customer 36 may receive an offer 12 via a telephone call 44 from a live or recorded customer service representative. The customer 36 may receive the offer via an e-mail message or on-line 46, for example, at a web site that is offered by or for a financial institution 32 or other merchant.

The offer extended 12 to the customer 36 may include, in addition to the conventional terms of an offer to open a prepaid account, terms of a special incentive in accordance with the present invention. These special incentive terms will typically include a minimum opening amount for the prepaid account, a time period or periods for which the customer must forego use of the account after it is opened in order to receive a reward, and the reward or rewards to be provided if the customer satisfies the conditions of the reward. The offer extended 12 may specify a single minimum opening amount, time period, and reward, or may allow the customer to select from among a variety of different combinations of minimum opening amounts, time periods and rewards. (The customer 36 may be able to select the desired reward from available offered rewards either at the time that the offer is accepted or later, at the time that the conditions for receiving the reward have been satisfied.) The offer extended 12 may include increasing rewards as the customer foregoes use of the prepaid account for longer time periods.

A variety of different types of rewards may be offered as part of a prepaid account incentive offer in accordance with the present invention. Such rewards may include money, merchandise, discounts, services, enrollment in loyalty programs, preferential treatments, rebates, and lottery or other contest entries.

Money rewards may be paid as an increase in the value of the prepaid account. For example, a customer 36 may agree to open a prepaid account for $100 and not to use the account for six months after purchasing it, at which time the value of the account is increased to $120. Alternatively, a money reward may take the form of a direct payment (e.g., via check) that is mailed 40 to the customer 36, a direct deposit to another financial account of the customer (e.g., maintained by the customer at the same financial institution 32 that issued the prepaid account), a separate prepaid payment card mailed 40 to the customer 36, etc.

Merchandise rewards may be provided to a customer 36 either by sending the merchandise itself to the customer 36 or by providing a certificate that can be redeemed for the merchandise at a local or on-line merchant. For example, a customer 36 may agree to open a prepaid account for $500 and not to use the account for six months, at which time the customer 36 or a designee is sent a DVD player (or a certificate that can be redeemed for one).

Discount rewards may include coupons that can be redeemed at local or online merchants. Discounts may be particularly applicable rewards for merchant issued prepaid accounts employing incentives in accordance with the present invention. For example, a customer 36 may open a prepaid account with a retail merchant for $500 and agree not to use it for six months, at which time the customer 36 will receive a coupon for a discount on their next purchase at the merchant.

Service rewards typically may be provided in the form of a certificate for the service provided. For example, a customer 36 may open a prepaid account for $500 and agree not to use it for six months in exchange for a certificate for a gym membership for three months.

As an example of a reward in the form of enrollment in a loyalty program, a customer 36 may open a prepaid account for $500 and agree not to use the account for six months, at which time the customer 36 will receive loyalty points or membership in an elite status with a merchant or service provider.

As an example of a reward in the form of preferential treatments, a customer 36 may open a prepaid account for $500 and agree not to use the account for six months, at which time the customer 36 will get guaranteed availability at a merchant or service provider.

As an example of a reward in the form of rebates, a customer 36 may open a prepaid account for $500 and agree not to use the account for six months, at which time the customer 36 would get a certificate for a discount off of a selected item or items at a selected merchant or merchants.

As an example of a reward in the form of a lottery entry, a customer 36 may open a prepaid account for $500 and agree not to use it for six months, at which time the customer 36 will be entered for a chance to win a prize. Prizes may be awarded to one or more account holders. Winners would be selected from account holder entries.

If the customer 36 agrees to the conditions of the prepaid account incentive offer he may accept the offer and fund the account 14. The customer 36 may accept the offer and fund 14 the prepaid account using any appropriate communications channel 38. The manner in which the customer 36 accepts 14 the offer and funds the account may depend upon the way in which the offer was received. For example, the customer 36 may respond to a mailed 40 offer by mailing 40 an acceptance back, sending an acceptance by facsimile 42 back, by calling 44 a toll-free customer service telephone number provided on the mailed 40 offer, or by accessing a web site 46 at a web site address provided on the offer. The customer 36 may accept 14 an offer received via the telephone 44 as part of the same telephone call with a customer service representative or VRU. The customer 36 may accept 14 an offer viewed on-line 46 by entering the acceptance 14 into a user interface provided on the web site at which the offer was made.

However the manner in which the customer 36 acceptance 14 of the offer is received by the system, the customer 36 will be required to provide or verify personal identification information needed to open the prepaid account. Such information may include the customer's name and address to which a prepaid account payment card and any rewards or reward certificates are to be mailed 40. The customer 36 will also be required to fund the account. This may also be accomplished in a variety of ways. For example, the customer 36 may provide a credit card number or the number of a deposit account owned by the customer 36 as part of the response and to which the price of the prepaid account is to be charged. Alternatively, the customer 36 may merely mail 40 a check or money order to cover the price of the prepaid account or provide authorization for an ACH debit to fund the account.

Upon receiving the customer's acceptance of the prepaid account incentive offer, and funding of the prepaid account, a prepaid account is opened 16 for the customer. This includes storing in the account database 34 the assigned account number along with the customer identifying information and the details of the time period(s) required for the customer to forego using the account in order for a reward to be issued and the details of the reward to be issued if such reward conditions are satisfied. The prepaid account is established at a par value of the amount paid by the customer to open the account less any initial fees that may have been disclosed to and accepted by the customer 36. (There may or may not be other fees charged to the account value for other services associated with the prepaid account, such as for additional payment cards for accessing the account, replacement cards, account upgrades, etc.)

With the prepaid account established 16, the processor 30 may preferably monitor two conditions, account activity and the passage of time since the account was established. The prepaid account may be activated simply by using an associated payment card or the account number to make a purchase, e.g., at a merchant 48. Alternatively, the account may be activated by the customer 36 contacting the processor 30, via an appropriate communications channel 38, explicitly to activate the account. For example, the account issuer may require that the customer 36 call 44 a toll free telephone number or access a particular web page 46 on the Internet to activate a prepaid account before purchases using the account will be accepted. In either case, by using the account or explicitly requesting activation, the customer 36 activates 52 the account. When the customer activates 52 the account, the system processor 30 retrieves from the account database 34 the time period for which the customer agreed to defer using the account in exchange for a reward. The system processor 30 then determines 54 if the retrieved time period from the opening of the account has elapsed. If it has not, the condition for receiving a reward has not been satisfied. No reward is issued. However, the account is now active 20 at the initial par value (or remaining value after the initial use charges are deducted therefrom). If the specified time period from the opening of the account has elapsed, the condition for receiving a reward has been satisfied. In this case the account is active for at least the initial par value and a reward is issued 22. (If the agreed upon reward was a money reward, the account may be activated at the par value plus the reward value amount.) The account database 34 may be updated to indicate the current value of the account as well as whether or not a reward has issued 22.

The processor system 30 may also periodically check the prepaid account information in the account database 34 to determine 56 whether or not the time period that the customer agreed to forego using the account has elapsed. If the time period has elapsed, the account database 34 is checked to verify 58 that the account has not been activated. If the account has been activated, before the time period elapsed, no reward is issued, and the account is active initially at the par value. If the account has not been activated the reward, or a notice of reward eligibility, may be issued 22, even though the account is still not activated. This process insures that the customer 36 receives the reward due him when the agreed upon time period for foregoing use of the account expires.

If the customer uses or activates the prepaid account before the agreed upon time period expires, and thus is not entitled to a reward, the customer 36 may be sent a message, automatically generated by the processor system 30, via, e.g., mail 40 or e-mail 46, to this effect. If the customer 36 is entitled to a reward, the processor 30 may automatically initiate issuance of the reward. For example, the processor system 30 may automatically increase the value of the prepaid account if the reward is a money reward to be paid in this form. Alternatively, the processor 30 may send a message to a merchant or other order fulfillment system or service to send a merchandise reward or certificate therefore or other coupon or certificate reward to the customer 36. The processor 30 may also, in such case, send a message, e.g., via mail 40 or email 46, to the customer 36, informing him that the conditions for the reward have been satisfied and that the reward is on the way.

As mentioned above, a prepaid account incentives system and method in accordance with the present invention may include establishing a series of increasingly long time periods from the time that an account is opened and providing increasing rewards to the customer 36 account holder for foregoing use of the account for the increasing time periods. Thus, the longer a customer 36 defers using a prepaid account, the greater the reward he may receive. In such a case, the customer 36 may receive more and more rewards as time passes, or a single reward of greater value as more time passes. Each of these cases may be handled slightly differently by the processor system 30.

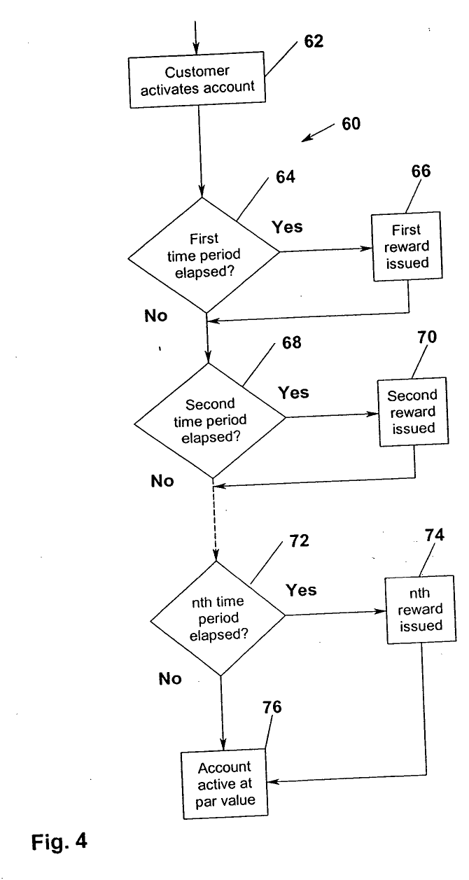

A portion of a process 60 for issuing a reward to a customer 36 where the reward is of increasing value depending upon how long the customer 36 has delayed using a prepaid account is illustrated in, and will be described with reference to, FIG. 4. This process 60 is initiated when the customer 36 activates 62 the account, e.g., by using the account to make a purchase. Upon activating the account 62 the system determines 64 whether the first and shortest agreed upon time period has elapsed since the account was opened. If the first time period has elapsed, the customer 36 will have earned 66 at least a first reward of a first value. The system 30 then determines 68 whether a second and longer time period has elapsed since the account was opened. If the longer time period has elapsed, the customer 36 will have earned 70 at least a second reward of a second value. The second reward may be a separate reward from the first reward or an increase in the first reward. For example, if the first reward is an increase in the account value of $X and the second reward is an increase in the account value of $Y then the total reward for delaying use of the card for the longer second time period is $X+$Y. This process is repeated by determining 72 if any further longer agreed upon time periods since the account was opened have expired and, if so, issuing 74 additional rewards or increasing the total value of the rewards issued. No matter how many, if any, rewards are issued, the prepaid account will be activated initially at at least the par value. In the process 60 illustrated in FIG. 4 the customer 36 receives all his due rewards (or a single greater reward) at the time that the prepaid account is activated.

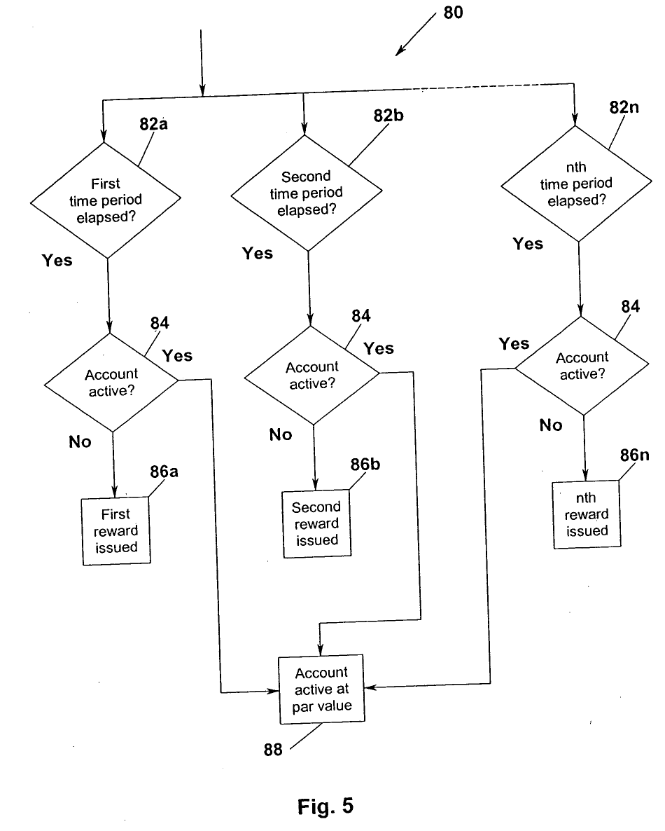

An alternative process 80 for issuing rewards in accordance with the present invention wherein increasing rewards are provided depending on how long the customer 36 forgoes using a prepaid financial account is illustrated in, and will be described with reference to, FIG. 5. In this case, the processor system 30 monitors the passage of time since the customer 36 opened a prepaid account and compares 82a-n the time passed with time periods established in the account database 34. If a time period since the account was opened has elapsed, the system 30 determines 84 if the account has been activated. If the account has not been activated, an appropriate reward is issued 86a-n. If the account has been activated, no additional reward is issued, and the account is activated 88 initially at par value. In the process illustrated in FIG. 5 the customer 36 receives rewards as time passes without the customer 36 using or otherwise activating the prepaid account. A combination of the processes 60 and 80 illustrated in FIGS. 4 and 5 for issuing rewards to prepaid account customers based on the time elapsed since the account was opened to the time the account is activated may also or alternatively be used in accordance with the present invention.

Although exemplary embodiments of the present invention have been shown and described with reference to particular exemplary applications thereof, it will be apparent to those having ordinary skill in the art that a number of changes, modifications, or alterations to the invention as described herein may be made, none of which depart from the spirit or scope of the present invention. All such changes, modifications, and alterations should, therefore, be seen as being within the scope of the present invention.

What is claimed is:

1. A method for providing an incentive to a holder of a prepaid financial account, comprising:
(a) establishing a prepaid financial account having an initial value and an agreed upon time period associated therewith;
(b) determining whether the prepaid financial account has remained inactive for a duration corresponding at least to the agreed upon time period;
(c) providing a reward to the holder of the prepaid financial account if the account has remained inactive for the duration corresponding at least to the agreed upon time period; and
(d) activating the prepaid financial account at the initial value.

2. The method of claim 1 wherein the value of the prepaid financial account is accessed using an identification process such as presentation of a payment card.

3. The method of claim 1 wherein providing a reward to the holder of the prepaid financial account includes increasing the initial value of the prepaid financial account.

4. The method of claim 1 wherein providing a reward to the holder of the prepaid financial account includes providing a reward selected from the group of rewards consisting of: money, merchandise, discounts, services, enrollment in loyalty programs, preferential treatments, rebates and lottery entries.

5. The method of claim 1 comprising additionally:
(a) extending an offer to a prospective account holder to open a prepaid financial account having at least a minimum initial value and specifying a time period and a reward;
(b) receiving from the prospective account holder an acceptance of the offer and an initial payment; and
(c) establishing the prospective account holder as the account holder, funding the initial value of the prepaid financial account from the initial payment, and establishing the agreed upon time period as the specified time period.

6. The method of claim 5:
(a) wherein extending an offer to a prospective account holder includes extending to the prospective account holder offers to open prepaid financial accounts wherein each of the offers specifies different combinations of minimum initial values, time periods, and rewards; and
(b) wherein receiving from the prospective account holder an acceptance of the offer includes receiving from the prospective account holder an acceptance of a one of the offers.

7. The method of claim 5:
(a) wherein extending an offer to a prospective account holder includes extending to the prospective account holder an offer to open a prepaid financial account having at least a minimum initial value and specifying a time period and rewards from which the prospective account holder is able to select; and
(b) wherein receiving from the prospective account holder an acceptance of the offer includes receiving from the prospective account holder a selection of a one of the specified rewards.

8. The method of claim 1 wherein providing a reward to the holder of a prepaid financial account includes:
(a) providing to the account holder a listing of a potential rewards;
(b) receiving from the account holder a selection of one of the potential rewards; and
(c) providing to the account holder the selected one of the potential rewards.

9. The method of claim 1 wherein determining whether the prepaid account has remained inactive for a duration corresponding to at least the agreed upon time period is performed upon activation of the account.

10. The method of claim 1 wherein determining whether the prepaid account has remained inactive for a duration corresponding to at least the agreed upon time period is performed periodically before the prepaid financial account is activated.

11. A method for providing an incentive to a holder of a prepaid financial account, comprising:
(a) establishing a prepaid financial account having an initial value and different agreed upon time periods associated therewith;
(b) determining whether the prepaid financial account has remained inactive for durations corresponding to each of the agreed upon time periods;
(c) providing a reward to the holder of the prepaid financial account wherein the reward provided is determined based on a number of the agreed upon time periods for which the account has remained inactive; and
(d) activating the prepaid financial account at the initial value.

12. The method of claim 11 wherein the value of the prepaid financial account is accessed using an identification process such as presentation of a payment card.

13. The method of claim 11 wherein providing a reward to the holder of the prepaid financial account includes providing a separate reward for each of the agreed upon time periods for which the account has remained inactive.

14. The method of claim 11 wherein providing a reward to the holder of the prepaid financial account includes providing a reward of increasing value for each of the agreed upon time periods for which the account has remained inactive.

15. The method of claim 11 wherein providing a reward to the holder of the prepaid financial account includes increasing the initial value of the prepaid financial account for each of the agreed upon time periods for which the account has remained inactive.

16. The method of claim 11 wherein providing a reward to the holder of the prepaid financial account includes providing a reward selected from the group of rewards consisting of: money, merchandise, discounts, services, enrollment in loyalty programs, preferential treatments, rebates and lottery entries.

17. The method of claim 11 wherein determining whether the prepaid financial account has remained inactive for durations corresponding to each of the agreed upon time periods is performed upon activation of the account.

18. The method of claim 11 wherein determining whether the prepaid financial account has remained inactive for a durations corresponding to each of the agreed upon time periods is performed periodically before the prepaid financial account is activated.

19. A computer implemented system for providing an incentive to a holder of a prepaid financial account, comprising:
(a) an account database having stored therein prepaid financial account information including an initial account value, an agreed upon time period, and account activation information;
(b) an account processor system coupled to the account database and adapted to:
(i) retrieve from the account database the agreed upon time period and the account activation information,
(ii) determine from the agreed upon time period and the account activation information whether the prepaid financial account has remained inactive for a duration corresponding at least to the agreed upon time period,
(iii) initiate providing a reward to the holder of the prepaid financial account if the account has remained inactive for the duration corresponding at least to the agreed upon time period, and
(iv) activate the prepaid financial account at the initial value.

20. The system of claim 19 wherein the account processor system is adapted to initiate providing a reward to the holder of the prepaid financial account by increasing the initial value of the prepaid financial account in the account database.

21. The system of claim 19 wherein the account processor system is adapted to initiate providing a reward to the holder of the prepaid financial account by providing a message to indicate that a reward selected from the group of rewards consisting of: money, merchandise, discounts, services, enrollment in loyalty programs, preferential treatments, rebates and lottery entries is to be provided to the account holder.

22. The system of claim 19 wherein the account processor system is coupled to communication channels and is further adapted to:
(a) extend via the communications channels an offer to a prospective account holder to open a prepaid financial account having at least a minimum initial value and specifying a time period and a reward;
(b) receive from the prospective account holder via the communications channels an acceptance of the offer and an initial payment; and
(c) establish in the account database the prospective account holder as the account holder, store the initial value of the prepaid financial account in the account database based upon the initial payment, and establish in the account database the agreed upon time period as the specified time period.

23. The system of claim 22 wherein the account processor system is adapted to:
(a) extend via the communications channels to the prospective account holder offers to open prepaid financial accounts wherein each of the offers specifies different combinations of minimum initial values, time periods, and rewards; and
(b) receive from the prospective account holder via the communications channels an acceptance of a one of the offers.

24. The system of claim 22 wherein the account processor system is adapted to:
(a) extend via the communications channel to the prospective account holder an offer to open a prepaid financial account having at least a minimum initial value and specifying a time period and rewards from which the prospective account holder is able to select;
(b) receive from the prospective account holder via the communications channels an acceptance including a selection of a one of the specified rewards; and
(c) storing in the account database an indication of the selected one of the specified rewards.

25. The system of claim 22 wherein the account processor system is coupled to communications channels selected from the group of communications channels consisting of mail, telephone, facsimile, and on-line communications channels.

26. The system of claim 19 wherein a card is issued or alternative access to a payment network is adapted to monitor use transactions accessing the account value and is adapted to determine whether the prepaid financial account has remained inactive for a duration corresponding to at least the agreed upon time period in response to a monitored use transaction.

27. The system of claim 26 wherein the account processor system is adapted to monitor use transactions accessing the account value that are initiated using a payment card.

28. The system of claim 19 wherein the account processor system is adapted to determine whether the prepaid financial account has remained inactive for a duration corresponding to at least the agreed upon time period periodically before the prepaid financial account is activated.

29. The system of claim 19 wherein the account database includes stored therein prepaid financial account information including different agreed upon time periods associated therewith and wherein the account processor system is adapted to:
(a) retrieve from the account database the different agreed upon time periods,
(b) determine from the retrieved different agreed upon time periods and the account activation information whether the prepaid financial account has remained inactive for durations corresponding to each of the agreed upon time periods, and
(c) initiate providing a reward to the holder of the prepaid financial account wherein the reward provided is determined based on a number of the agreed upon time periods for which the account has remained inactive.

30. The system of claim 29 wherein the system processor is adapted to initiate providing a reward to the holder of the prepaid financial account by increasing in the account database the initial value of the prepaid financial account for each of the agreed upon time periods for which the account has remained inactive.
